(19) United States
(12) Patent Application Publication
(10) Pub. No.: US 2014/0218525 A1
(43) Pub. Date: Aug. 7, 2014

(54) Method for determining a pitch of a camera installed in a vehicle and method for controling a light emission of at least one headlight of a vehicle.

(71) Applicants: Stefan Sellhusen, Weinstadt (DE); Thusitha Parakrama, Stuttgart (DE)

(72) Inventors: Stefan Sellhusen, Weinstadt (DE); Thusitha Parakrama, Stuttgart (DE)

(21) Appl. No.: 14/122,183

(22) PCT Filed: May 8, 2012
(86) PCT No.: PCT/EP2012/058454

§ 371 Date: Mar. 27, 2014

(30) Foreign Application Priority Data
May 31, 2011 (DE) 10 2011 076 795.9

(51) Int. Cl. G06K 9/00; H04N 17/00

(52) U.S. Cl. CPC G06K 9/00791; H04N 17/002
USPC 348/148

(57) ABSTRACT

A method for determining a pitch of a camera installed in a vehicle includes: production of first image gradient data from a first camera image, the first image gradient data representing a brightness change of adjacent pixels of the first camera image along a vertical axis of the first camera image; production of second image gradient data from a second camera image recorded subsequent to the first camera image, the second image gradient data representing a brightness change of adjacent pixels of the second camera image along a vertical axis of the second camera image; generation of an image displacement value, which represents a displacement of a pixel of the second camera image in relation to a corresponding pixel of the first camera image; and ascertainment of a pitch based on the image displacement value.

### BACKGROUND OF THE INVENTION

1. Field of the Invention

The present invention relates to a method for determining a pitch of a camera installed in a vehicle, to a method for controlling a light emission of at least one headlight of the vehicle, to a device which is designed to carry out the steps of such a method, and to a computer program product having program code which is stored on a machine-readable carrier, for carrying out such a method when the program is executed on a device.

2. Description of the Related Art

One of the most important safety functions which is available in a modern video-based driver assistance system is the tracking and position estimation of the preceding vehicles or obstructions in the travel direction, in order to initiate automatic full braking of the vehicle in the case of dangerously close or shrinking distances. The precision of the tracking and the distance to the vehicle or obstruction are primarily dependent on the egomotion, i.e., the motion parameters, of the camera at this special point in time. The pitch of the camera strongly influences the estimation of the distance to the object. It may also be observed that the sensitivity to the pitch angle is very high and a slight change of the pitch angle may induce a large error in the distance estimation. The most well-known systems for determining a pitch of an internal vehicle camera are typically based on pitch angular velocity sensors installed on the chassis.

A vehicle recognition device for recognizing vehicles is disclosed in published German patent document DE 10 2007 041 781 B1, the vehicles traveling with turned-on lights on a roadway.

### BRIEF SUMMARY OF THE INVENTION

Against this background, the present invention provides an improved method for determining a pitch of a camera installed in a vehicle, an improved method for controlling a light emission of at least one headlight of a vehicle, an improved device, which is designed to carry out the steps of such a method, and an improved computer program product having program code which is stored on a machine-readable carrier, for carrying out such a method when the program is executed on a device.

The present invention provides a method for determining a pitch of a camera installed in a vehicle, the method having the following steps:

producing first image gradient data from a first camera image, the first image gradient data representing a brightness change of adjacent pixels of the first camera image along a vertical axis of the first camera image, and producing second image gradient data from a second camera image recorded subsequently with respect to the first camera image, the second image gradient data representing a brightness change of adjacent pixels of the second camera image along a vertical axis of the second camera image;
generating at least one image displacement value, which represents a displacement of a pixel of the second camera image in relation to a corresponding pixel of the first camera image, the generation being carried out using the first image gradient data and the second image gradient data; and
ascertaining a pitch based on the at least one image displacement value, to determine the pitch of the camera.

The vehicle may be a motor vehicle, for example, a passenger automobile, a truck, or another utility vehicle. The camera is attached in the vehicle in such a way that a viewing angle of the camera is oriented in the forward travel direction or in the reverse travel direction of the vehicle. A first camera may also be provided having a viewing angle in the forward travel direction and a second camera may be provided having a viewing angle in the reverse travel direction of the vehicle. With the aid of the camera, an area which is located ahead of the vehicle in the forward travel direction may be recorded. The camera may be used for monitoring and/or tracking preceding vehicles or objects located ahead of the vehicle, for example. The camera may be aligned with its optical axis along a longitudinal axis of the vehicle. The pitch relates to a rotatory motion or pivot of the camera around a transverse axis of the vehicle. The pitch causes the optical axis of the camera to be pivoted with respect to the longitudinal axis of the vehicle around the transverse axis. Since the camera is mechanically connected to the vehicle, the pitch of the camera results from a corresponding motion of the vehicle. Conclusions about a motion behavior of the vehicle may thus also be drawn from the pitch of the camera. A translational motion of the camera along a vertical axis of the vehicle may also cause an image displacement, but by a negligible absolute value, however. The first camera image and the second camera image may be directly sequential camera images or at least one intermediate image may be recorded by the camera between the first camera image and the second camera image. The image gradient data represent a brightness change along at least one vertical row or column of pixels. The pixels may be so-called image pixels. The first image gradient data may be represented by a first signal. The second image gradient data may be represented by a second signal. The image displacement value specifies whether a pitch of the camera has occurred between a recording point in time of the first camera image and a recording point in time of the second camera image and how large the pitch is.

Furthermore, the present invention provides a method for controlling a light emission of at least one headlight of a vehicle, a camera being installed in the vehicle, the method having the following steps:

determining a pitch of a camera installed in a vehicle according to the above-mentioned method; and
setting an illumination angle of the at least one headlight as a function of the pitch of the camera, to control the light emission of the at least one headlight.

The above-mentioned method for determining may advantageously be used in conjunction with the method for control. The pitch of the camera determined with the aid of the method for determining, which originates from a corresponding motion of the vehicle, may be used in the method for control to set the illumination angle. The illumination angle may be corrected by the pitch. Thus, for example, glare of preceding vehicles or oncoming traffic by the at least one headlight of the vehicle may thus be reduced or prevented.

Furthermore, the present invention provides a device which is designed to carry out or implement the steps of one of the above-mentioned methods. In particular, the device may have units which are each designed to execute one step of one of the methods. The object on which the present invention is based may also be achieved advantageously and efficiently by this embodiment variant of the present invention in the form of a device.

A device may be understood in the present case as an electrical device, which processes sensor signals and outputs control signals or data signals as a function thereof. The device may have an interface, which may be designed as hardware or software. In the case of a hardware design, the interfaces may be part of a so-called system ASIC, for example, which contains greatly varying functions of the device. However, it is also possible that the interfaces are separate integrated circuits or are at least partially made of discrete components. In the case of a software design, the interfaces may be software modules, which are provided on a microcontroller in addition to other software modules, for example.

A computer program product having program code is also advantageous, which is stored on a machine-readable carrier such as a semiconductor memory, a hard drive memory, or an optical memory, and is used to carry out one of the above-mentioned methods when the program is executed on a device or a control unit.

The present invention is based on the finding that a determination of the pitch of the camera installed in a vehicle may be carried out based on camera images. For example, if a pitch of the camera occurs between recording points in time of two camera images, the pitch results in a displacement of pixels. This displacement of pixels may in turn be ascertained or precisely estimated according to specific embodiments of the present invention.

According to the present invention, a pure camera pitch may advantageously be determined or estimated, which is not the case with a sensor-based determination or estimation. According to the present invention, for example, pitch angular velocity sensors for determining the pitch of the camera may therefore be omitted. This saves parts, costs, and weight and avoids a situation in which the camera and the pitch angular velocity sensors are installed at different points and in relation to different coordinate systems. Therefore, according to the present invention, a susceptibility to errors, due to electromagnetic interference or temperature, in particular drift or offset, may be remedied or substantially reduced. Due to the interference-prone sensor system, which is not required, the determination of the pitch angle according to the present invention is free of such interference. Furthermore, camera image recording and pitch angle determination may be synchronized, since the determination is based on the instantaneously existing images. By way of the use of image gradient summation data instead of the entire image data of a camera image, a reduction of redundant information, and therefore also of required computing resources, and an increase of the computing efficiency additionally result. Therefore, a task to be fulfilled by the camera, for example, object tracking, may be improved. Due to a compensation of the camera pitch or camera pitch angular velocity, the improvement of the object tracking, for example, the moving object tracking, and an improvement of the object tracking precision result. This also has advantageous effects, for example, in conjunction with lane recognition algorithms having the target function of lane departure warning and lane keeping assistance, and/or object recognition, or the recognition of vehicles, persons, traffic signs, and the like.

For example, a lane departure warning and/or lane keeping assistance may be improved in conjunction with a backup camera.

In the step of production, the first and/or second image gradient data may be produced with the aid of a radon transformation, in particular a radon transformation in the horizontal direction with respect to the affected camera image. The radon transformation is an integral transformation. In this case, the radon transformation may take into consideration a brightness change of adjacent pixels from multiple columns of pixels. The brightness changes in the multiple columns of pixels may be successively integrated in this case, the columns being processed successively in the horizontal direction. This specific embodiment offers the advantage that with the aid of the radon transformation, with reasonable resource expenditure, informative image gradient data may be produced based on not only one column of pixels. An image displacement value may be efficiently generated based on the image gradient data produced with the aid of radon transformation.

Furthermore, it is favorable if in the step of production, the first image gradient data are produced from a subarea of the first camera image and the second image gradient data are produced from a corresponding subarea of the second camera image. Such a specific embodiment of the present invention offers the advantage of significantly reduced required data processing capacity for the production of the first and second image gradient data, since only a small part of the first and second images has to be analyzed.

In the step of generation, the at least one image displacement value may also be generated with the aid of a cross correlation from the first image gradient data and the second image gradient data. For this purpose, the step of generation may have an estimation, and in particular a subpixel-precision estimation. The estimation on the basis of the cross correlation is highly precise, with a high resolution of less than one pixel (subpixel), for example.

In the step of ascertainment, a pitch angular velocity may be ascertained, to determine the pitch of the camera. This specific embodiment offers the advantage that the pitch may be determined in the form of the pitch angular velocity in an uncomplicated way.

In this case, in the step of ascertainment, a pitch angular velocity may be ascertained based on the at least one image displacement value, a time difference between the first camera image and the second camera image, and a focal length of the camera, to determine the pitch of the camera. This specific embodiment offers the advantage that based on the above-mentioned input variables, the pitch angular velocity may be ascertained in a simple and precise way.

In particular, in the step of ascertainment, a pitch angular velocity may be ascertained according to the formula

$$δ \dot{θ} = \frac{Δ y}{Δ {tf}_{y}}$$

to determine the pitch of the camera. In this formula, δ\dot{θ} may designate the pitch angular velocity as a derivative of a pitch angle change δθ, Δy may designate the at least one image displacement value, Δt may designate a time difference between the first camera image and the second camera image, and f_{y} may designate a focal length of the camera. This specific embodiment offers the advantage that the pitch angular velocity may be ascertained reliably and with efficient calculation with the aid of the above formula.

It is also favorable if in the step of production, the first image gradient data are produced from a subsection of the first camera image and the second image gradient data are produced from a subsection of the second camera image. The subsection of the first camera image and the subsection of the second camera image may be based on a single subarea of a camera sensor in this case. Therefore, the line positions and column positions of the subsections may be identical with respect to an unvarying pixel raster in the camera images. The line positions and column positions of the subsections do not change from the first camera image to the second camera image with respect to the unvarying pixel raster. The subsections may be adaptable to an image width and an image height. This specific embodiment offers the advantage that the resource outlay for the determination of the pitch of the camera is reduced, since the input data set is reduced, in that only subsections of the camera images and not entire camera images are used in the step of the production. In addition, the subsections of the camera images may be selected in such a way that the subsections have informatively analyzable areas of the camera images with respect to the pitch of the camera.

The method may also have a step of selecting a subsection from the first camera image and a subsection from the second camera image. The step of selection may be carried out based on a progress of the vehicle and additionally or alternatively based on the least possible influencing of the subsection by the progress of the vehicle.

For example, a lane and/or object recognition may have a step of carrying out a lane and/or object detection, a step of executing lane and/or object tracking and positioning with the aid of the camera motion or pitch angular velocity, and a step of activating an actuator, to output an item of information to a driver of the vehicle, for example, or to intervene in an active and correcting way.

### BRIEF DESCRIPTION OF THE DRAWINGS

FIG. 1 shows a vehicle having a control unit according to one exemplary embodiment of the present invention.

FIG. 2 shows camera images and a subsection of a camera image according to one exemplary embodiment of the present invention.

FIG. 3 shows a subsection of a camera image and image gradient data according to one exemplary embodiment of the present invention.

FIG. 4 shows a graph of a pitch angular velocity curve obtained with the aid of sensors in a conventional way and a pitch angular velocity curve determined according to exemplary embodiments of the present invention.

FIGS. 5 and 6 show flow charts of methods according to exemplary embodiments of the present invention.

### DETAILED DESCRIPTION OF THE INVENTION

Identical or similar elements may be provided in the figures with identical or similar reference numerals, a repeated description being omitted. It is clear to those skilled in the art that these features may also be considered individually or may be combined into further combinations which are not explicitly described here. Furthermore, the present invention is possibly explained in the following description with the use of different amounts and dimensions, the present invention being understood to not be restricted to these amounts and dimensions. Furthermore, method steps according to the present invention may be executed repeatedly and in a sequence other than that described. If an exemplary embodiment includes an “and/or” link between a first feature/step and a second feature/step, this may be read to mean that the exemplary embodiment has according to one specific embodiment both the first feature/the first step and also the second feature/the second step and has according to another specific embodiment either only the first feature/step or only the second feature/step.

FIG. 1 shows a vehicle having a control unit according to one exemplary embodiment of the present invention. A vehicle 100, a camera 110, a control unit 120, a determination unit 130, a generation unit 140, and an ascertainment unit 150 are shown. Control unit 120 has determination unit 130, generation unit 140, and ascertainment unit 150. Camera 110 and control unit 120 are situated in vehicle 100. Camera 110 has a communication connection to control unit 120. Determination unit 130 has a communication connection to generation unit 140 of control unit 120. Generation unit 140 has a communication connection to ascertainment unit 150 of control unit 120.

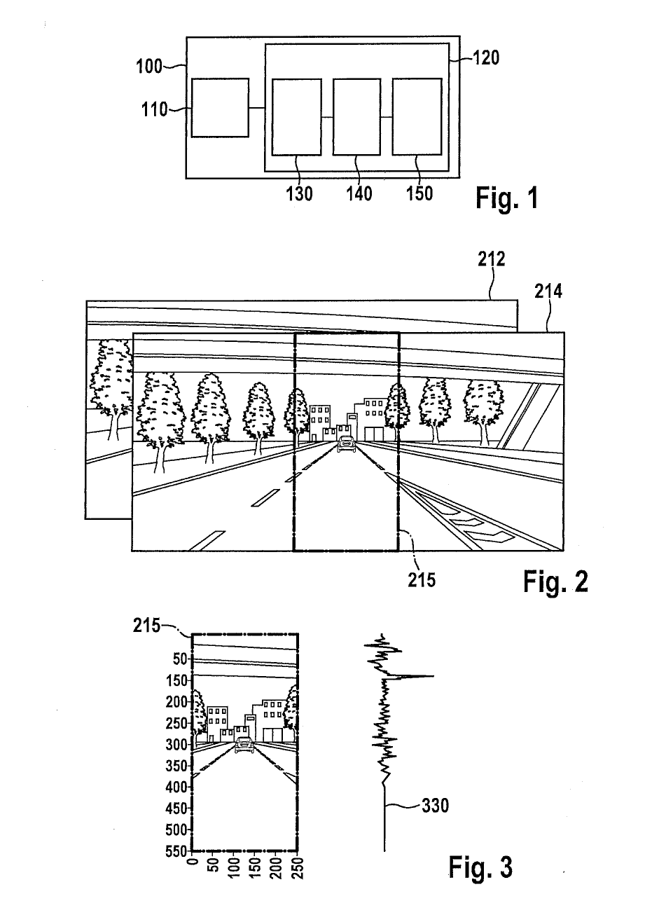

Camera 110 is situated in vehicle 100 in such a way that camera images are recordable in the forward travel direction of vehicle 100 with the aid of optical units of camera 110, even if the situation of camera 110 in vehicle 100 is not explicitly shown in FIG. 1. The camera images will be discussed in greater detail with reference to FIG. 2. Camera 110 is connected via a signal line or the like to control unit 120, for example. Camera 110 is designed to transmit image data, which represent the camera images, to control unit 120.

Control unit 120 receives the camera images in the form of the image data from camera 110. Control unit 120 is designed to determine a pitch of camera 110, which is installed in a vehicle. For this purpose, for example, pairs of successive camera images are processed by units 130, 140, and 150 up to control unit 120. In other words, at least one pair of sequential or successive camera images is processed in control unit 120. A sequence of the processing in control unit 120 is explained hereafter solely for one pair of such camera images. However, it is apparent that the sequence may be repeated for further pairs of such camera images.

Production unit 130 is designed to produce first image gradient data from a first camera image. The first image gradient data represent a brightness change of adjacent pixels of the first camera image along a vertical axis of the first camera image. Production unit 130 is also designed to produce second image gradient data from a second camera image, which is recorded subsequently with respect to the first camera image. The second image gradient data represent a brightness change of adjacent pixels of the second camera image along a vertical axis of the second camera image. The first image gradient data and the second image gradient data are transmitted by production unit 130 to generation unit 140. The first image gradient data may be transmitted in this case as a first image gradient signal. The second image gradient data may be transmitted as a second image gradient signal.

Generation unit 140 receives the first image gradient data and the second image gradient data from production unit 130. Generation unit 140 is designed to generate an image displacement value while using the first image gradient data and the second image gradient data. The image displacement value represents a displacement of a pixel of the second camera image in relation to a corresponding pixel of the first camera image. In other words, generation unit 140 analyzes the first and the second image gradient signals, which represent the first and the second image gradient data, to generate the image displacement value. The image displacement value is transmitted from generation unit 140 to ascertainment unit 150.

Ascertainment unit 150 receives the image displacement value from generation unit 140. Ascertainment unit 150 is designed to ascertain a pitch based on the image displacement value, to determine the pitch of the camera. In particular, ascertainment unit 150 may calculate a pitch angular velocity from the image displacement value and further data for this purpose, as explained in greater detail hereafter.

FIG. 2 shows camera images and a subsection of a camera image according to one exemplary embodiment of the present invention. A first camera image 212, a second camera image 214, and a subsection 215 are shown. Camera images 212, 214 may be recorded with the aid of a camera like the camera from FIG. 1. The camera, using which camera images 212, 214 are recorded, may be installed in a vehicle, such as the vehicle from FIG. 1. In FIG. 2, second camera image 214 is shown partially concealing or overlapping first camera image 212. However, it is apparent from FIG. 2 that first camera image 212 and second camera image 214 show similar scenery. The scenery may be recognized completely in second camera image 214. Second camera image 214 shows a street scene from the perspective of a vehicle interior through a windshield of the vehicle in the forward travel direction. A road having roadway markings, a preceding vehicle, a bridge which spans the roadway, and structures and vegetation are shown.

First camera image 212 is recorded chronologically before second camera image 214, for example. The vehicle in which the camera is installed may have progressed by a certain distance, and a pitch of the vehicle and/or of the camera may have occurred between a recording point in time of first camera image 212 and a recording point in time of second camera image 214. Therefore, image data of camera images 212, 214 and therefore also the objects visible in camera images 212, 214 may differ as a result of a progress distance of the vehicle and additionally or alternatively a pitch of the vehicle and/or the camera.

Subsection 215 includes a subarea of second camera image 214. More precisely, subsection 215 includes a subarea of second camera image 214 in which the preceding vehicle is imaged. Subsection 215 extends according to the exemplary embodiment shown in FIG. 2 from an upper image edge to a lower image edge of second camera image 214. A height of subsection 215 therefore corresponds here to a height of second camera image 214. A width of subsection 215 may be a fraction of a width of second camera image 214, as shown in FIG. 2, or may be up to the width of second camera image 214, depending on the requirements of a special application. A height of subsection 215 may be a fraction of a height of second camera image 214, as shown in FIG. 2, or may be up to the height of second camera image 214, depending on the requirements of a special application. Subsection 215 may be determined in this case with the aid of a unit of a control unit, for example, the generation unit or a unit of the control unit from FIG. 1, which is connected upstream from the generation unit.

FIG. 3 shows a subsection of a camera image and image gradient data according to one exemplary embodiment of the present invention. A subsection 215 of a camera image and image gradient data 330 in the form of a graph of brightness values or an image gradient signal are shown. Subsection 215 may be the subsection of the second camera image from FIG. 2. Subsection 215 in FIG. 3 may, however, be changed with respect to an image contrast and the like based on the subsection of the second camera image from FIG. 2, for example, in such a way that image gradient data 330 may advantageously be produced. Image gradient data 330 may be produced from subsection 215 with the aid of a suitable unit, for example, the production unit of the control unit from FIG. 1. Image gradient data 330 are shown on the right next to subsection 215 in FIG. 3. Image gradient data 330 represent brightness values or brightness changes of one or more columns of pixels of subsection 215 from an upper edge to a lower edge of subsection 215. Image gradient data 330 are shown in FIG. 3 as a vertical graph of brightness values extending next to subsection 215. Outliers of the graph to the left and right represent brightness changes between pixels of subsection 215. Image gradient data 330 or the graph of brightness values may be provided in the form of an image gradient signal.

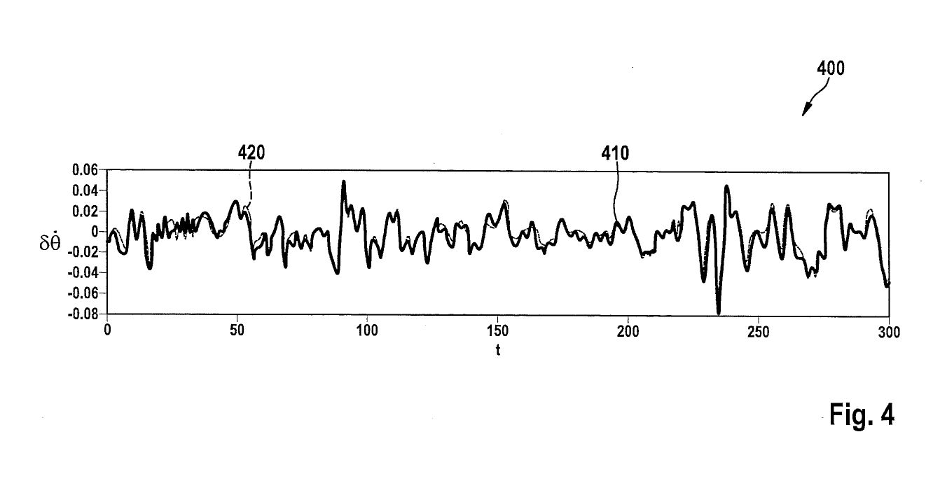

FIG. 4 shows a graph 400 of a curve 410, which is obtained with the aid of sensors in a conventional way, of a pitch angular velocity δ\dot{θ} of a camera installed in a vehicle over time t and a curve 420, which is determined according to exemplary embodiments of the present invention, of a pitch angular velocity δ\dot{θ} of a camera installed in a vehicle over time t. The graph of curve 410 obtained with the aid of sensors in a conventional way is produced, for example, using ground truth data, measured by a high-resolution pitch angular velocity sensor or the like. The graph of curve 420, which is determined according to exemplary embodiments of the present invention, of pitch angular velocity δ\dot{θ} may be determined using the control unit from FIG. 1. It is apparent here that curve 420, which is determined according to exemplary embodiments of the present invention, almost exactly follows curve 410, which is obtained with the aid of high-resolution sensors in a conventional way.

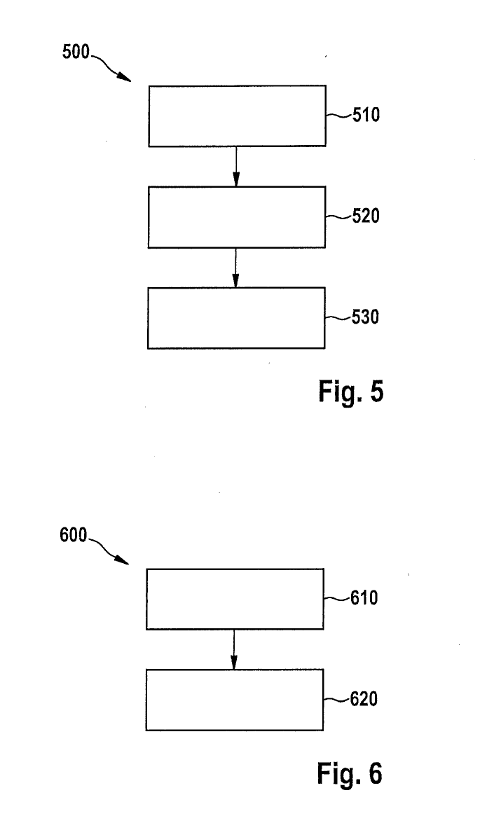

FIG. 5 shows a flow chart of a method 500 for determining a pitch of a camera installed in a vehicle, according to one exemplary embodiment of the present invention. Method 500 has a step of production 510 of first image gradient data from a first camera image and second image gradient data from a second camera image, which is recorded subsequently with respect to the first camera image. The first image gradient data represent a brightness change of adjacent pixels of the first camera image along a vertical axis of the first camera image. The second image gradient data represent a brightness change of adjacent pixels of the second camera image along a vertical axis of the second camera image. Method 500 also has a step of generation 520 of at least one image displacement value, which represents a displacement of a pixel of the second camera image in relation to a corresponding pixel of the first camera image. The step of generation 520 is carried out using the first image gradient data and the second image gradient data. Method 500 also has a step of ascertainment 530 of a pitch based on the at least one image displacement value, to determine the pitch of the camera. Steps 510, 520, and 530 of method 500 may be executed repeatedly, to determine a pitch of the camera continuously based on a plurality of first camera images and second camera images.

FIG. 6 shows a flow chart of a method 600 for controlling a light emission of at least one headlight of a vehicle, a camera being installed in the vehicle, according to one exemplary embodiment of the present invention. Method 600 has a step of determination 610 of a pitch of a camera installed in a vehicle according to the method for determining a pitch of a camera installed in a vehicle according to the exemplary embodiment of the present invention shown in FIG. 5. The step of determination 610 may thus have substeps, which correspond to the steps of the method for determining a pitch of a camera installed in the vehicle according to the exemplary embodiment of the present invention shown in FIG. 5. Method 600 also has a step of setting 620 of an illumination angle of the at least one headlight as a function of the pitch of the camera, to control the light emission of the at least one headlight.

Various exemplary embodiments of the present invention will be explained in summary hereafter with reference to FIGS. 1 through 6. FIG. 2 shows a typical street scene having a preceding vehicle. To determine the camera movement or image displacement, two such successive camera images 212, 214 are observed. Only the image area bounded by the box is also taken into consideration, for example, subsection 215. A further reduction of redundant items of information is carried out via the one-dimensional gradient in the vertical direction of the particular camera image. The items of horizontal edge information are amplified and the vertical items of information are filtered out. Furthermore, the dimension reduction is carried out via the one-dimensional radon transformation in the horizontal direction of the subsection of the camera image. As a result, a one-dimensional or 1D signal is obtained, as shown in FIG. 3 in the form of image gradient data 330. This process is executed for the two successive camera images 212, 214 at point in time (t−1) and (t). If one observes two successive 1D signals or image gradient data 330, it is apparent that these two signals are slightly displaced in relation to one another. This displacement may be estimated, for example, by the cross correlation method with decimal point precision. The displacement value may thus be generated. The following method is used to determine the pitch angular velocity. The estimated or generated displacement of the image with the aid of cross correlation methods is Δy, a camera focal length is f_{y}, a pitch angle change is δθ, and an image time difference between two successive images is Δt. The pitch angular velocity thus results according to the following formula:

$$δ \dot{θ} = \frac{Δ y}{Δ {tf}_{y}} .$$

Provided method 500 for determining the pitch of camera 110 is applicable to video-based driver assistance functions which use, for example, monocular and stereo-vision algorithms. The ascertainment of the pitch angular velocity is carried out in this case, for example, in a very high resolution having high computing efficiency. Normally, as a result of the pitch of camera 110, entire camera image 212, 214 is moved vertically upward or downward. This is considered to be a displacement in camera images 212, 214, when two successive camera images 212, 214 are affected. If the image displacement is estimated at subpixel precision, for example, the change of the pitch angle may be calculated at the same precision. The redundant items of information of camera images 212, 214 are pre-filtered, and the 2D displacement is therefore resolved further into a 1D displacement of the image, to allow a calculation in real time.

According to exemplary embodiments of the present invention, a real-time estimation of the pitch or pitch angular velocity of camera 110 and finally a compensation of this movement are made possible. Thus, for example, a tracking precision and estimation of the distance to an object may also be improved. The determination of the pitch angular velocity is executed, for example, on the basis of visual features and without sensor assistance. An improvement of the moving object tracking may therefore be achieved by a compensation of the camera pitch angular velocity. The improvement of the object tracking precision is made possible via the compensation of the camera pitch.

1-11. (canceled)

12. A method for determining a pitch of a camera installed in a vehicle, comprising:
producing (i) first image gradient data from a first camera image, wherein the first image gradient data represent a brightness change of adjacent pixels of the first camera image along a vertical axis of the first camera image, and (ii) second image gradient data from a second camera image recorded subsequent to the first camera image, wherein the second image gradient data represent a brightness change of adjacent pixels of the second camera image along a vertical axis of the second camera image;
generating, using the first image gradient data and the second image gradient data, at least one image displacement value representing a displacement of a pixel of the second camera image in relation to a corresponding pixel of the first camera image; and
ascertaining a pitch based on the at least one image displacement value, to determine the pitch of the camera.

13. The method as recited in claim 12, wherein at least one of the first image gradient data and the second image gradient data are produced with the aid of a radon transformation in the horizontal direction with respect to the corresponding camera image.

14. The method as recited in claim 12, wherein the first image gradient data are produced from a subarea of the first camera image and the second image gradient data are produced from a corresponding subarea of the second camera image.

15. The method as recited in claim 14, wherein the at least one image displacement value is generated with the aid of a cross-correlation from the first image gradient data and the second image gradient data.

16. The method as recited in claim 12, wherein a pitch angular velocity is ascertained to determine the pitch of the camera.

17. The method as recited in claim 16, wherein the pitch angular velocity is ascertained on the basis of the at least one image displacement value, a time difference between the first camera image and the second camera image, and a focal length of the camera.

18. The method as recited in claim 17, wherein the pitch angular velocity is ascertained according to the formula
$$δ \dot{θ} = \frac{Δ y}{Δ {tf}_{y}} ,$$
to determine the pitch of the camera, δ\dot{θ} designating the pitch angular velocity as a derivative of a pitch angle change δ\dot{θ}, Δy designating the at least one image displacement value, Δt designating a time difference between the first camera image and the second camera image, and f_{y} designating a focal length of the camera.

19. The method as recited in claim 17, wherein the first image gradient data are produced from a subsection of the first camera image and the second image gradient data are produced from a subsection of the second camera image.

20. A method for controlling a light emission of at least one headlight of a vehicle, wherein a camera is installed in the vehicle, the method comprising:
determining a pitch of a camera installed in a vehicle by:
producing (i) first image gradient data from a first camera image, wherein the first image gradient data represent a brightness change of adjacent pixels of the first camera image along a vertical axis of the first camera image, and (ii) second image gradient data from a second camera image recorded subsequent to the first camera image, wherein the second image gradient data represent a brightness change of adjacent pixels of the second camera image along a vertical axis of the second camera image;
generating, using the first image gradient data and the second image gradient data, at least one image displacement value representing a displacement of a pixel of the second camera image in relation to a corresponding pixel of the first camera image; and
ascertaining a pitch based on the at least one image displacement value, to determine the pitch of the camera; and
setting an illumination angle of the at least one headlight as a function of the pitch of the camera, to control the light emission of the at least one headlight.

21. A control unit for determining a pitch of a camera installed in a vehicle, comprising:
means for producing (i) first image gradient data from a first camera image, wherein the first image gradient data represent a brightness change of adjacent pixels of the first camera image along a vertical axis of the first camera image, and (ii) second image gradient data from a second camera image recorded subsequent to the first camera image, wherein the second image gradient data represent a brightness change of adjacent pixels of the second camera image along a vertical axis of the second camera image;
means for generating, using the first image gradient data and the second image gradient data, at least one image displacement value representing a displacement of a pixel of the second camera image in relation to a corresponding pixel of the first camera image; and
means for ascertaining a pitch based on the at least one image displacement value, to determine the pitch of the camera.

22. A non-transitory computer-readable data storage medium storing a computer program having program codes which, when executed on a computer, perform a method for determining a pitch of a camera installed in a vehicle, the method comprising:
producing (i) first image gradient data from a first camera image, wherein the first image gradient data represent a brightness change of adjacent pixels of the first camera image along a vertical axis of the first camera image, and (ii) second image gradient data from a second camera image recorded subsequent to the first camera image, wherein the second image gradient data represent a brightness change of adjacent pixels of the second camera image along a vertical axis of the second camera image;
generating, using the first image gradient data and the second image gradient data, at least one image displacement value representing a displacement of a pixel of the second camera image in relation to a corresponding pixel of the first camera image; and
ascertaining a pitch based on the at least one image displacement value, to determine the pitch of the camera.
